(19) United States
(12) Patent Application Publication
(10) Pub. No.: US 2013/0036351 A1
(43) Pub. Date: Feb. 7, 2013

(54) APPARATUS, SYSTEM, AND METHOD FOR DYNAMICALLY CUSTOMIZING A WEB PAGE

(71) Applicants: Trajan King, Kaysville, UT (US); Joel Otterstrom, Salt Lake City, UT (US); John Peterson, Hong Kong (CN)

(72) Inventors: Trajan King, Kaysville, UT (US); Joel Otterstrom, Salt Lake City, UT (US); John Peterson, Hong Kong (CN)

(21) Appl. No.: 13/564,535

(22) Filed: Aug. 1, 2012

Related U.S. Application Data
(60) Provisional application No. 61/513,946, filed on Aug. 1, 2011.

(51) Int. Cl. G06F 17/00

(52) U.S. Cl. 715/234

(57) ABSTRACT

The apparatus for dynamically customizing a web page includes a characteristic module configured to obtain one or more visitor characteristics from a visitor visiting a web page. The web page is owned by a website owner. The apparatus includes a determination module configured to determine a customizable area on the web page. The customizable area includes a portion of the web page. The apparatus includes a customization module configured to provide web page content for the customizable area. The web page content is based on the one or more visitor characteristics of the visitor. The web page content includes content of the website owner.

### CROSS-REFERENCES TO RELATED APPLICATIONS

This application claims the benefit of U.S. Provisional Patent Application No. 61/513,946 entitled “APPARATUS, SYSTEM, AND METHOD FOR DYNAMICALLY CUSTOMIZING A WEB PAGE” and filed on Aug. 1, 2011 for Trajan King et al., which is incorporated herein by reference.

### TECHNICAL FIELD

The present disclosure, in various embodiments, relates to web pages and more particularly relates to dynamically customizing web pages.

### BACKGROUND

Visitors to web pages may have different interests, come from different locations on the Internet, and/or be searching for different things. However, typically, the content displayed on a web page is the same regardless of the visitor.

Once a website is created and placed on the Internet, a typical website owner may not readily dictate how or what visitors link to, index, and/or refer to on the website. A website owner may reconfigure a website, but this takes time and resources and such modifications are still unable to accommodate specific interests of visitors.

### SUMMARY

One embodiment of an apparatus for dynamically customizing a web page includes a characteristic module configured to obtain one or more visitor characteristics from a visitor visiting a web page. The web page is owned by a website owner. The apparatus includes a determination module configured to determine a customizable area on the web page. The customizable area includes a portion of the web page. The apparatus includes a customization module configured to provide web page content for the customizable area. The web page content is based on the one or more visitor characteristics of the visitor. The web page content includes content of the website owner.

In some implementations of the apparatus, the one or more visitor characteristics include keyword information, referring information, demographic information, browser information, device type, time, and/or social networking information. According to certain implementations of the apparatus, the customization module is further configured to insert the web page content into the customizable area during loading of the web page. In one implementation, the apparatus includes a visitor profile module configured to create a visitor profile for the visitor and store one or more of the visitor characteristics and web page viewing behavior of the visitor in the visitor profile.

According to certain implementations, the apparatus includes a visitor profile module configured to recognize the visitor as being associated with an existing visitor profile and update the existing visitor profile based on one or more of the visitor characteristics and web page viewing behavior of the visitor. According to certain implementations, the apparatus includes a campaign module configured to locate a web content campaign corresponding to the one or more visitor characteristics. According to a further implementation the apparatus includes a content determination module configured to determine the web page content based on the web content campaign.

Another embodiment of an apparatus for dynamically customizing a web page includes a receiving module configured to receive one or more visitor characteristics from a website host. The one or more visitor characteristics are associated with a visitor visiting a web page of the website host. The apparatus includes a content determination module configured to determine web page content for a customizable area on the web page. The web page content is determined based at least in part on the one or more visitor characteristics. The apparatus includes a notification module configured to notify the website host of the web page content for the website host to insert the web page content into the customizable area.

In some implementations, the one or more visitor characteristics include keyword information, referring information, demographic information, browser information, device type, time, and/or social networking information. In certain implementations, the website host inserts the web page content into the web page substantially during loading of the web page. In some implementations, the content determination module is further configured to locate a web content campaign corresponding to the one or more visitor characteristics and determine the web page content based on the web content campaign.

According to some implementations, the apparatus further includes a visitor profile module configured to create a visitor profile for the visitor. The visitor profile includes the visitor characteristics and/or web page viewing behavior of the visitor. In certain implementations, the apparatus further includes a visitor profile module configured to recognize the visitor as being associated with an existing visitor profile and update the existing visitor profile based on one or more of the visitor information and web page viewing behavior of the visitor.

According to some implementations, the notification module is further configured to notify the website host of characteristics of the customizable area on the web page. The characteristics include a customizable area location and/or a customizable area size. In certain implementations, the content determination module is configured to receive a notification from the website host that a hidden Uniform Resource Locator (URL) in the web page has been visited. The content determination module is configured to determine the web page content based in part on the hidden URL.

According to certain implementations, the receiving module is further configured to receive from the website host, web page viewing behavior of the visitor visiting the web page of the website host. The content determination module stores the web page viewing behavior for future content determination.

Yet another embodiment of an apparatus for dynamically customizing a web page includes a characteristic determination module configured to determine one or more visitor characteristics of a visitor visiting a web page hosted by a Website host The apparatus includes a communication module configured to send the one or more visitor characteristics to a content determination entity and configured to receive a content specification specifying web page content for a customizable area on the web page. The web page content is determined based at least in part on the one or more visitor characteristics. The apparatus includes an insertion module configured to insert the web page content into the customizable area during loading of the web page. The web page content is managed by the Website host.

In certain implementations, the one or more visitor characteristics comprise keyword information, referring information, demographic information, browser information, device type, time, and/or social networking information. According to some implementations, the apparatus further includes a history module configured to list a hidden Uniform Resource Locator (URL) in the web page and configured to determine, using a web browser for the webpage, that the URL has been visited. In some implementations, the communication module is further configured to send history information to the content determination entity. The history information specifies that the URL has been visited and the web content is based at least in part on the history information. According to some implementations, the content specification specifies characteristics of the customizable area on the web page. The characteristics include one or more of a customizable area location and a customizable area size.

One embodiment of a method for dynamically customizing a web page includes obtaining one or more visitor characteristics from a visitor visiting a web page. The web page is owned by a website owner. The method includes a determining a customizable area on the web page. The customizable area includes a portion of the web page. The method includes providing web page content for the customizable area. The web page content is based on the one or more visitor characteristics of the visitor. The web page content includes content of the website owner.

Another embodiment of a method for dynamically customizing a web page includes receiving one or more visitor characteristics from a Website host. The one or more visitor characteristics are associated with a visitor visiting a web page of the website host. The method includes determining web page content for a customizable area on the web page. The web page content is determined based at least in part on the one or more visitor characteristics. The method includes notifying the website host of the web page content for the website host to insert the web page content into the customizable area.

Yet another embodiment of a method for dynamically customizing a web page includes determining one or more visitor characteristics of a visitor visiting a web page hosted by a website host. The method includes sending the one or more visitor characteristics to a content determination entity and receiving a content specification specifying web page content for a customizable area on the web page. The web page content is determined based at least in part on the one or more visitor characteristics. The method includes inserting the web page content into the customizable area during loading of the web page. The web page content is managed by the website host.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. The disclosure may be practiced without one or more of the specific features or advantages of a particular embodiment. In other instances, additional features and advantages may be recognized in certain embodiments that may not be present in all embodiments of the disclosure.

These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the present subject matter will be readily understood, a description of the present subject matter will be rendered by reference to specific embodiments that are illustrated in the appended drawings. Understanding that these drawings depict only typical embodiments of the present subject matter and are not therefore to be considered to be limiting of its scope, the present subject matter will be described and explained with detail through the use of the accompanying drawings, in which:

FIG. 1 is a schematic block diagram illustrating one embodiment of a system for dynamically customizing a web page in accordance with the present subject matter;

FIG. 2 is a schematic block diagram illustrating one embodiment of a process flow in accordance with the present subject matter;

FIG. 3 is a schematic flow chart diagram illustrating one embodiment of a apparatus for dynamically customizing a web page in accordance with the present subject matter;

FIG. 4A is a schematic flow chart diagram illustrating another embodiment of a apparatus for dynamically customizing a web page in accordance with the present subject matter;

FIG. 4B is a schematic flow chart diagram illustrating yet another embodiment of a apparatus for dynamically customizing a web page in accordance with the present subject matter;

FIG. 5 is a schematic flow chart diagram illustrating one embodiment of a method for dynamically customizing a web page in accordance with the present subject matter;

FIG. 6 is a schematic flow chart diagram illustrating one embodiment of a method for dynamically customizing a web page in accordance with the present subject matter; and

FIG. 7 is a schematic flow chart diagram illustrating one embodiment of a method for dynamically customizing a web page in accordance with the present subject matter.

### DETAILED DESCRIPTION

As will be appreciated by one skilled in the art, aspects of the present subject matter may be embodied as a system, method or computer program product. Accordingly, aspects of the present subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present subject matter may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present subject matter. Thus, appearances of the phrases “in one embodiment,” “in an embodiment,” and similar language throughout this specification may, but do not necessarily, all refer to the same embodiment.

Furthermore, the described features, structures, or characteristics of the present subject matter may be combined in any suitable manner in one or more embodiments. In the above description, numerous specific details were provided, such as examples of programming, software modules, user selections, network transactions, database queries, database structures, hardware modules, hardware circuits, hardware chips, etc., to provide a thorough understanding of embodiments of the present subject matter. One skilled in the relevant art will recognize, however, that the present subject matter may be practiced without one or more of the specific details, or with other methods, components, materials, and so forth. In other instances, well-known structures, materials, or operations are not shown or described in detail to avoid obscuring aspects of the present subject matter.

Aspects of the present subject matter were described above with reference to schematic flowchart diagrams and/or schematic block diagrams of methods, apparatuses, systems, and computer program products according to embodiments of the present subject matter. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present subject matter. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

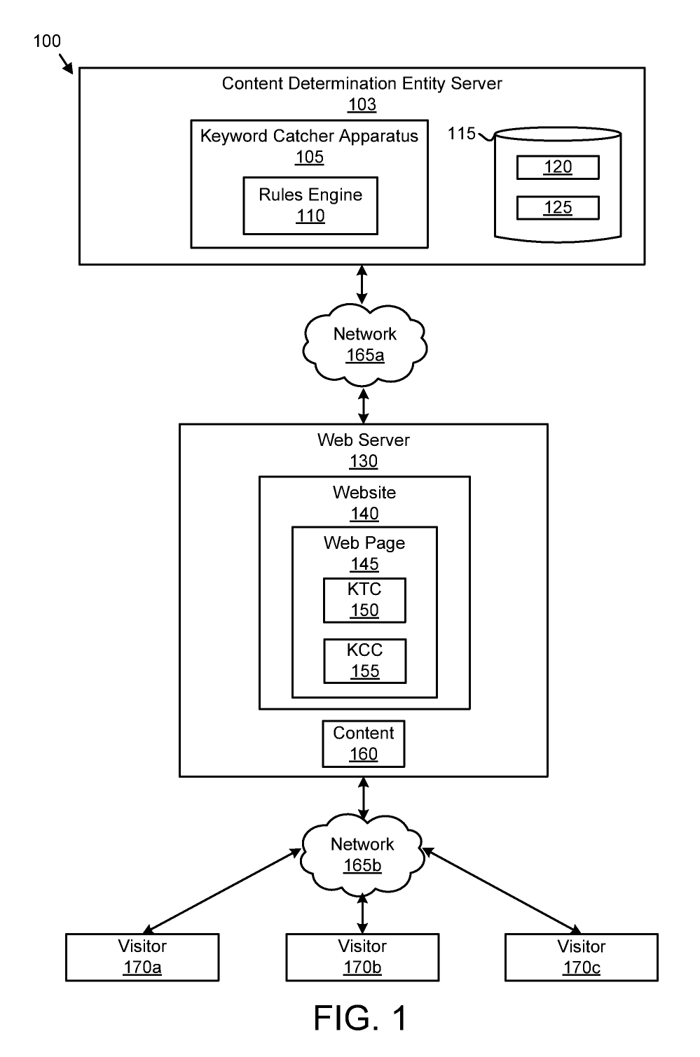

FIG. 1 is a schematic block diagram illustrating one embodiment of a system 100 for dynamically customizing a web page. The system 100 includes a Content Determination Entity server 103 with a Keyword Catcher Apparatus 105, a Web server 130, a network 165, and a plurality of Visitors 170a-c.

The Content Determination Entity server 103 may be a server owned, managed, and/or controlled by a Content Determination Entity. The Content Determination Entity is an entity that hosts, provides, manages, and/or operates the Keyword Catcher Apparatus 105 for one or more Website Owners. In one embodiment, the Content Determination Entity is independently owned and operated from the Website Owners and may, for example, be a third-party web service provider that provides web services to the Website Owners. For example, the Content Determination Entity may provide the Keyword Catcher Apparatus 105 under a software as a service (“SAAS”) model. The Keyword Catcher Apparatus 105 allows a website owner, such as an online webmaster or web marketer, to adjust, adapt, and/or customize its website to react to web interactions created by search engines, social media portals, and referring traffic.

Although a single server 103 is depicted, the Content Determination Entity server 103 and/or the Keyword Catcher Apparatus 105 may include and/or be implemented by multiple servers along with storage, databases and other infrastructure. One or more servers comprising the Content Determination Entity server 103 may be embodied as a computing device including a desktop computer, a server, a mainframe computer, and the like and may include memory storing computer readable programs with a processor that executes the computer readable programs as is known to those skilled in the art.

The Keyword Catcher Apparatus 105 includes a Rules Engine module 110. The Content Determination Entity server 103 includes memory storing a Knowledge Base 120 and Visitor Profiles 125 as described below. In one embodiment, the Knowledge Base 120 and the Visitor Profiles 125 are stored in a database or other suitable electronic storage system. Any suitable type of database such as MySQL, Sybase, Oracle, Postgres, or MSSQL, may be used. The Visitor Profiles 125 and the Knowledge Base 120 are described below.

In the depicted embodiment, a Web server 130 communicates with the Keyword Catcher Apparatus 105 (e.g. through the Content Determination Entity server 103). The Web server may include application software and/or a computing device with memory storing computer readable programs with a processor that executes the computer readable programs as is known to those skilled in the art to host, provide, and/or server web pages 145.

The Web server 130 may be a Website Owner server—a server owned, managed, commissioned by and/or controlled by a Website Owner—and may host, provide, store, and/or serve one or more websites 140 of the Website Owner. For example, the Web server 130 may be owned and operated by the Website Owner. A Website owner, in certain embodiments, may also be referred to as a Website Host and the Web server 130 as the Website Host server.

In one embodiment, the web page 145 and website 140 is hosted or provided for the Website Owner by another entity. In these embodiments, the web page 145 and website 140 are hosted and provided by a Web server 130 that is not owned and operated by the Website Owner. Therefore, in various embodiments, the term Website Host may refer to either the Website Owner or an entity providing hosting for the Website Owner. Similarly, the term Website Host server may refer to a web server owned and/or controlled by the Website Owner or a server owned and/or controlled by a different entity than the Website Owner that provides hosting for the Website Owner's content 160, website 140, and web page 145. In either case, the Website Owner may provide, control, and or own the Website Owner's web page 145, website 140, and/or content 160 for insertion in the web page 145 as described below.

The Website Owner may include, but is not limited to, an entity that interacts directly with the Keyword Catcher Apparatus 105, such as a webmaster, an online marketer, a web designer, a website owner, and/or the like. The Website Owner may also be referred to as an ecommerce business owner (“EBO”). Although a single server 130 is depicted, the Website Owner and/or Website Host may control and/or use a plurality of servers and include storage, databases and other infrastructure to provide the website 140.

The Web server 130 may communicate with the Keyword Catcher Apparatus 105 by way of a network such as a global communications network 165a including the Internet, a Local Area Network (“LAN”), a plurality of LANs, or the like. Furthermore, the website 140 includes at least one web page 145 with a Keyword Catcher Tracking Code (“KTC”) 150 and at least one Keyword Catcher Campaign Code (“KCC”) 155 as described below. In addition, although a single Web server 130 is depicted, the Content Determination Entity server 103 may communicate with and provide website content determination services for multiple Web servers.

The Web server 130 may communicate with one or more Visitors 170a-c by way of a network 165b such as the Internet, a Local Area Network (“LAN”), a plurality of LANs, or other suitable network. Although two networks 165a, 165b are depicted, one skilled in the art realizes that a single network may be used (e.g. the Internet) for communication between the Content Determination Entity server 103 and the Web server 130, and communication between the Web server 130 and the one or more Visitors 170a-c.

A Visitor 170a-c may comprise an entity that interacts indirectly with the Keyword Catcher Apparatus 105 but directly with the website 140 and/or Web server 130. A Visitor 170a-c may refer to a client, an application such as an Internet browser, a process, and/or a person communicating with the Web server 130 over the network 165b. A Visitor 170a-c may include, but is not limited to, a search engine, a social media portal, a website owner, an affiliate marketer, a website customer, and/or the like. In certain embodiments, a Visitor 170a-c is also known as an Organic Traffic Driver (“OTD”). A Visitor 170a-c may be a person operating a browser executing on a client device (e.g. a smartphone) and accessing and/or downloading the web page 145 as is known in the art.

Once a website is created and placed on the Internet, a typical Website Owner may not readily dictate how or what Visitors 170a-c link to, index, and/or refer to on the website. The Keyword Catcher Apparatus 105 allows the Website Owner to handle interactions between the Visitors 170a-c and the website 140 in real time. Specifically, in one embodiment, the Keyword Catcher Apparatus 105 creates, stores, and/or manages web content campaigns to present to Visitors 170a-c in real time as the Visitors 170a-c interact with one or more Website Owner websites 140. These web content campaigns may be based on visitor characteristics such as keywords, referring websites, and/or the like. The web content campaigns may specify, define, and/or dictate what content the Keyword Catcher Apparatus 105 will supply to certain customizable areas (KCCs) in the web pages 145 of the website 140 as described below.

In one embodiment, the Keyword Catcher Apparatus 105 adds visitor characteristics such as country, page visitation information, and the like, to the knowledge base 120 used by Keyword Catcher Apparatus 105 for use in determining what web content campaigns to present.

A web content campaign may specify content 160 such as images, videos, flash, and anything else that is readable by standard internet browsers. As depicted, in one embodiment, content 160 such as videos, images, and other creative assets are stored, provided, and/or controlled by the Website Owner, such as on the Web server 130. Conventional website analytics typically focus on a potential customer's interactions with a particular web site. The Keyword Catcher Apparatus 105, however, may focus on both the interactions of Visitors 170a-c and potential customers, thereby gathering a larger set of data to determine what content to present to customize the web page as described below.

The Website Owner (e.g. a Web Developer of the Website Owner) may place KTC 150 on each web page the Website Owner desires the Keyword Catcher apparatus 105 to present customized web content to Visitors 170a-c. The KTC 150 gathers information from Visitors 170a-c by capturing visitor characteristics. In one embodiment, the visitor characteristics include keyword information. Keyword information includes the search terms entered by a Visitor 170a-c, such as in a search engine, which caused the web site 140 to be presented to the Visitor 170a-c, such as in a list of search results. Visitor characteristics may include referring information, which is a referring source, such as a previous website in which the Visitor had visited before visiting the website 140. Referring sources may include search engines, web-based email programs such as Gmail, Hotmail, and the like. Visitor characteristics may include demographic information such as countries in which the Visitors 170a-c are located, browser information, such as a Visitor's browser, device type, such as the type of client device of the Visitor 170a-c, time information, and social networking information. For example, in certain embodiments, social networking websites may interface with the website 140, sharing user profile information of the Visitor 170a-c with the website 140. In one embodiment, the KTC 150 is a Java script which is included on the website 140 (e.g. on web pages 145 of the website 140). In a further embodiment, the KTC 150 resides in the “<Head>” tag on web pages 145 of the website 140.

In one embodiment, the Website Owner (e.g. a Web Developer of the Website Owner) may place KCC 155 on every website 140 web page 145 the Website Owner desires the Keyword Catcher Apparatus 105 to present web content campaigns to Visitors 170a-c. In other embodiments, the KCC 155 may be defined by the KTC 150 at run-time (e.g. when the web page 145 is loaded by the Web server 130) based on predefined parameters entered into, for example, an authoring tool of the Keyword Catcher Apparatus 105. The web content campaign may provide rules specifying which content the KTC 150 will populate each KCC 155. As a result, the web page 145 may be customized, dynamically (e.g. substantially during loading of the web page 145) depending on visitor characteristics of the Visitor 170a visiting the web page 145 without the Website Owner having to reconfigure the website 140. Furthermore, in one embodiment, the Uniform Resource Locator (“URL”) of the web page 145 and/or the website 140 may remain consistent (e.g. the URL remains the same each time the Visitor 170a visits the web page 145 and/or the website 140).

In one embodiment, KCCs 155 do not replace website theme designs, but replace sections of HTML snippets within a website 140 web page 145. As a result, a Visitor 170a may still interact with the website 140 in a search engine friendly manner. The KTC 150 may interact with the Visitors 170a-c and set the web content campaigns as described below. In one embodiment, the Website Owner may place any suitable number of KCC 155 on a web page.

In one embodiment, the one or more KCC 155 include Java script code and are positioned on the web page 145 where the Website Owner best feel a customizable area may attract a Visitor 170a and/or are added during loading of the web page 145 based on predefined characteristics as described above. KCCs 155 may interact and communicate with the KTC 150 through REST and/or SOAP API formats or other suitable communication format. In one embodiment, each KCC 155 has associated default HTML and/or content, which will be displayed if no campaign HTML is presented through the KTC 150.

The Keyword Catcher Apparatus 105 detects visitor characteristics from Visitors 170a-c such as referring information and search engine keywords. Visitor characteristics may also include information from Social Media profiles. In one embodiment, the Keyword Catcher Apparatus 105 detects these visitor characteristics using the KTC 150 in the website head tag on the web page 145. The KTC 150 gathers the characteristics and may add them to the web content campaign knowledge base 120. The knowledge base 120 for the Keyword Catcher Apparatus 105 of the website may grow as more visitor characteristics are gathered by the KTC 150. As the knowledge base 120 grows, the Keyword Catcher Apparatus 105 may better determine what web content campaign to present to the KTC 150, which may then set the KCC 155. The rules engine 110 rules may be configured by Keyword Catcher Apparatus 105 analysis and/or by the Website Owner's business goals and rules. For example, a rule of the rules engine 110 may include: If the referrer web site is Facebook from a profile other than the Website Owner's profile, then display particular content in a particular KCC 155 or refer to a particular web content campaign.

In one embodiment, a potential Website Owner visitor profile 125 is created when a web content campaign is found by the Keyword Catcher Apparatus 105. Furthermore, in one embodiment, a default HTML snippet is shown if no web content campaign can be determined by the Keyword Catcher Apparatus 105.

In one embodiment, the Keyword Catcher Apparatus 105 tracks web traffic from Visitors 170a-c (such as potential Website Owner customers) through the website 140 until a particular Visitor 170a reaches a final tracking web page 145. The final tracking web page 145 may be a “thank you” web page 145, and/or a receipt page in the Website Owner's sales or lead generation cycle. The final tracking web page 145 may include a separate tracking code. In one embodiment, the final tracking web page 145 does not include a KTC. This final tracking code (“KFTC”) updates the customer's visitor profile 125 as determined by the rules engine 110 to indicate to the Website Owner that a new customer has been captured by the Keyword Catcher Apparatus 105 in response to interactions of a particular Visitor 170a. The Keyword Catcher Apparatus 105, in one embodiment, sets and/or updates a value on the new customer's visitor profile 125. If the visitor characteristics of a Visitor 170a match visitor characteristics stored in a pre-existing visitor profile 125, the rules engine 110 may use rules associated with that visitor profile 125 in determining a particular web content campaign and/or content for a particular KCC 155.

In certain embodiments, the KFTC resides on web pages 145 with some kind of available action such as making a purchase, signing up for a newsletter, an email campaign. The KFTC may indicate to the Keyword Catcher Apparatus 105, that an action has been taken and the visitor profile of the Visitor and/or the knowledge base may be updated to reflect the action and/or the associated web content campaign.

Moreover, references herein to the Content Determination Entity may also include references to the Content Determination Entity server 103. References herein to the Website Host or Website Owner may also include references to the Web server 130 for the Website Host or the Website Owner respectively.

In one embodiment, a Website Owner (e.g. a representative of a Website Owner) may login to a Keyword Catcher Apparatus administration panel with a secure username and password. The Keyword Catcher Apparatus administration panel may present the Website Owner representative with options to interact with the Keyword Catcher Apparatus 105. Those options may include, but is not limited to, keywords management, referrer management, web content campaign management, reporting, and settings.

Visitor characteristics may be included in part of the knowledge base 120. As described above, visitor characteristics may be gathered and placed into the knowledge base 120 by the KTC 150 from interactions from the Visitors 170a-c. In one embodiment, the Website Owner is not able to add visitor characteristics manually to the knowledge base lists.

In one embodiment, the Website Owner may create groupings of Keywords that are part of rules for the rules engine 110. Keywords may be associated with sales cycles, product reviews, or the like.

The Website Owner may examine stored visitor characteristics to optimize attention grabbing personalized experiences for its potential or current customers on the Website Owner's web site 140. The Website Owner may then create a web content campaign that may appeal to a particular Visitor 170a based on the visitor characteristics. For example, if the Website Owner reviews the stored visitor characteristics and finds that several Visitors 170a-c visit the website 140 after having entered search terms related to “flowers,” the Website Owner may create a web content Campaign directed at customized content associated with flowers.

In one embodiment, content 160 including creative and Website Owner assets (besides HTML code) are stored on the Web server 130 or are otherwise controlled and/or provided by the Website Owner. A web content campaign may include images, content, videos, flash, HTML, and anything else that is readable by a standard Internet browser. A web content campaign may also include knowledge base rules such as country, categories, keyword groupings, and the like, any number of KCC HTML snippets, and at least one or two visitor characteristic elements (e.g. certain keywords, referrer sites, and the like). Web content campaigns may be accessible by the rules engine 110 and may be tested on a Multi Variant Testing Level to understand what web content campaign is working on what KCC 155. For example, a Website Owner may use split-testing to determine what content appeals to which Visitors 170a-c. In split-testing, a Website Owner may have a particular web content campaign present different content to different Visitors 170a-c. The Website Owner may then analyze the results of the web content campaign, including whether Visitors 170a-c completed a purchase more often when viewing certain content, and the like.

The Keyword Catcher Apparatus 105 may also provide reports. The Website Owner may examine reports of how Visitors are interacting with the Website Owner's web site 140. The Website Owner may also examine the visitor profiles of Visitors interacting with the Website Owner's web site 140, bringing a different perspective on the Website Owner interactions with potential or actual customers. In one embodiment, the reports are geared towards understanding what web content campaigns to present to the incoming potential customer and where to best place KCCs 155.

The Website Owner, in one embodiment, may configure the Keyword Catcher Apparatus 105 to ignore traffic from Visitors 170a-c that the Website Owner is not interested in, countries it is not interested in, and/or the like. In one embodiment, the Website Owners may also set default HTML snippets to be shown when the rules engine 110 cannot determine a campaign to display for the Visitor interaction.

Although, in the depicted embodiment, the Keyword Catcher Apparatus 105 is located on the Content Determination Entity server 103 and is separate from the Web server 130 with the web page 145 having the KTC 150, in other embodiments, the Keyword Catcher Apparatus 105 is located on a common server with the web page 145 having the KTC 150. For example, in certain embodiments, both the Keyword Catcher Apparatus 105 and the web pages 145 with KTC 150 may be located on the Web server 130. Furthermore, although the KTC 150 is depicted as residing on the web page 145, all or a portion of the KTC 150 may reside elsewhere on the Web server 130, such as, for example, executing as one or more computer readable programs on the Web server 130.

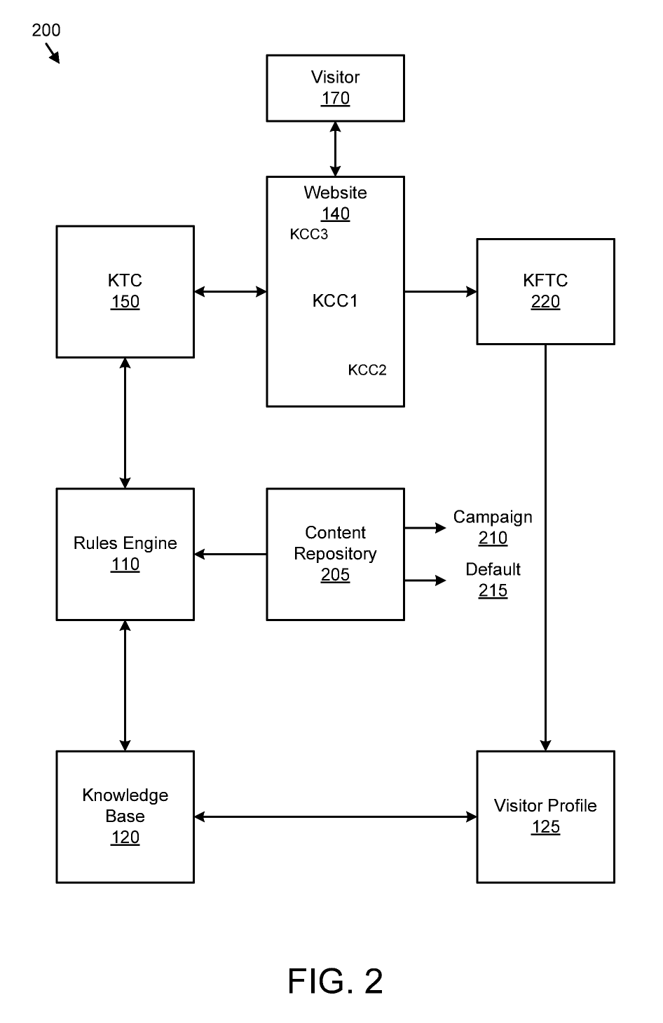

FIG. 2 is a schematic block diagram illustrating one embodiment of a process flow 200 in accordance with the present subject matter. Visitors 170 such as search engines, social media portals, affiliate marketing web sites, website owners, blog owners, Website Owner customers, and the like, visit an Website Owner website 140. The KTC 150 profiles the Visitors 170 and communicates with the rules engine 110 for web content campaign information.

The rules engine 110 examines KTC profile data and knowledge base 120 from the database 115 and the rules engine returns web content campaign data to the KTC 150 to set KCC 155. The rules engine 110 also creates a potential visitor profile 125. The KTC 150 sets individual KCC 155 as determined by the rules engine profile data and knowledge base 120. The KCC 155 shows HTML data and/or other content on the Website Owner's web site 140 where each KCC 155 was strategically placed, thus customizing web pages 145 of the website 140 based on the profile data in accordance with the web content campaign. The Keyword Catcher Apparatus 105 continues to track and update the visitor profile for the particular Visitor until it reaches the KFTC 220.

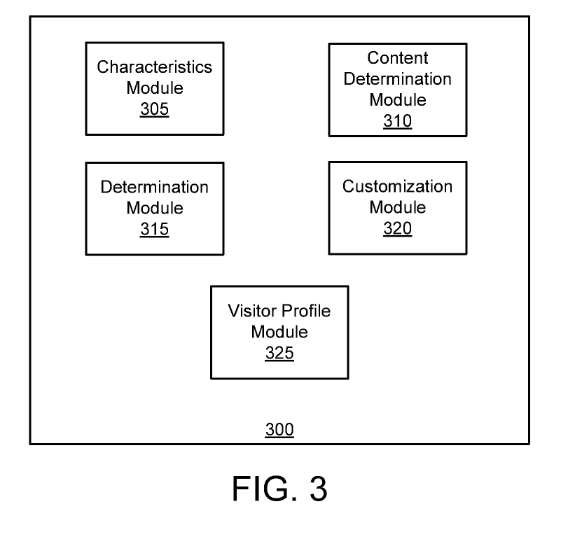

FIG. 3 illustrates one embodiment of an apparatus 300 for dynamically customizing a web page in accordance with the present subject matter. The apparatus 300 includes one or more of a characteristics module 305, a content determination module 310, a determination module 315, a customization module 320, and a visitor profile module 325. The apparatus 300 may be one embodiment of the Keyword Catcher Apparatus 105, the KTC 150, and/or other code executing on the Web server 130. For example, the modules and/or portions of the modules may reside on the Content Determination Entity server 103, the Web server 130, and/or the like.

The characteristics module 305, in one embodiment, obtains one or more visitor characteristics from a Visitor 170a-c visiting a web page 145. The web page 145 may be a portion of a website 140 and may be owned by a Website Owner. To be owned by the Website Owner means to be provided, managed, commissioned and/or controlled by the Website Owner. The website 140 may be hosted by a Web server 103 as described above. As stated above, the one or more visitor characteristics may include keyword information, referring information, demographic information, browser information, device type, time, and/or social networking information.

The characteristics module 305 may be embodied as code on the web page 145, such as part of the KTC 110 and/or may obtain the visitor characteristics from the URL, the web browser of the Visitor 170a-c, and/or the Web server 103 (e.g. the server hosting the web page 145). For example, the characteristics module 305 may obtain search keywords from the URL of the Visitor 170a-c as it reaches the web page 145, may obtain the referring source from the Visitor's web browser and/or the web server 130 loading the web page, and the like.

In another embodiment, the characteristics module 305 obtains the visitor characteristics from the KTC 150. For example, if the characteristics module 305 resides on the Content Determination Entity server 103, the characteristics module 305 may receive the visitor characteristics over the network, such as with an HTTP or HTTPS request/response.

The content determination module 310, in one embodiment, determines web page content for customization of the web page 145. The web page content may be based on a web content campaign. A web content campaign is a group, a specification, and/or a collection of web page content and/or indicators (such as file path names or Javascript code or HTML snippets) of web page content. Each web content campaign may be associated with certain visitor characteristics, certain web page viewing behavior, and/or the like. For example, a web content campaign may be associated with searches on the keywords “flowers” or “roses” and may include web content specification indicating web content having to do with flowers or roses. In one embodiment, the web content campaign includes file path names pointing to content stored on the Web server 103. The content determination module 310, in one embodiment, locates a web content campaign corresponding to the one or more visitor characteristics. In one embodiment, the content determination module 310 includes and/or is embodied by the rules engine 110 as described above.

Web content campaigns may be created by users such as Website Owners, may be determined by the content determination module 305 based on information in the Knowledge Base 120. For example, if Visitors 170a-c who land on the web page 145 after searches with the keyword “flowers” make a number of purchases over a threshold, the content determination module 310 may create a web content campaign for the keyword flowers with images of flowers and/or content related to flowers.

The determination module 315, in one embodiment, determines a customizable area on the web page 145. The customizable area may include a portion of the web page 145. The customizable area may be defined by a predetermined indicator, such as with HTML tags. In one embodiment, the customizable area is a KCC 155. Furthermore, a particular web page 145 may have multiple KCCs 155. As stated above, in one embodiment, a KCC 155 may be inserted on a web page 145 prior to the web page 145 being loaded and set apart with a predetermined indicator such as an HTML tag and the determination module 315 may determine the customizable area on the web page 145 by locating the predetermined indicator. In another embodiment, the determination module 315 may determine and/or establish the customizable area (the KCC 155) while the web page 145 is loaded based on a predetermined definition stored by the apparatus 300.

The customization module 320, in one embodiment, provides web page content for the customizable area. The web page content may be based on the one or more visitor characteristics of the Visitor 170a-c and may be derived from the web content campaign as described above. The web page content, in one embodiment, is content 160 of the Website Owner. For example, the Website Owner may own, manage, provide, store and/or control the web page content 160 along with the web page 145. The customization module 320, in one embodiment, may provide the web page content 160 by transmitting a content specification to the web page 145 (e.g. to the KTC 150). In one embodiment, the customization module 320 is embodied by the KTC 150 or other code executing on the web server 130 loading the web page 145 and may directly insert the content specification (e.g. file path names to images, animation, and the like) into the web page. In one embodiment, the customization module 320 inserts the web page content into the customizable area during loading of the web page 145.

In one embodiment, a web content campaign persists, for a particular Visitor 170a-c, for each web page 145 of the website viewed by the Visitor 170a-c. For example, a Visitor 170a-c who searched for trucks before landing on the web page 145 may have web content customized by the customization module 320 consistently based on a web content campaign directed at trucks. In one embodiment, a web campaign includes two or more sets of content to present to different Visitors 170a-c. For example, two Visitors 170a,b may trigger the same web content campaign assignment, yet receive different content (one Visitor 170a receives one set of web content and the other Visitor 170b receives the other set) to test which web content set is more effective at causing the Visitor 170a-c to make a sale, linger on the web page 145, or the like.

The visitor profile module 325, in one embodiment, creates a visitor profile for the Visitor 170a-c. The visitor profile may include Visitor identification information, such as IP address, location, browser, and the like. The visitor profile may also store the visitor characteristics and web page viewing behavior of the Visitor 170a-c. Web page viewing behavior may include an amount of time spent on web pages 145 of the website 140, purchases made on the website 140, actions taken on the website 140, or the like. In one embodiment, the visitor profile module 325 recognizes a Visitor 170a-c as being associated with an existing visitor profile. For example, a Visitor 170a-c may begin loading the web page 145 in the Visitor's browser and the visitor profile module 325 may recognize the Visitor 170a-c as having visited the web page 145 and/or website 140 before. The visitor profile module 325 may update the existing visitor profile based on the visitor characteristics (e.g. search terms that brought the Visitor 170a-c most recently to the web page 145) and web page viewing behavior of the Visitor 170a-c as the Visitor 170a-c navigates web pages 145 of the website 140.

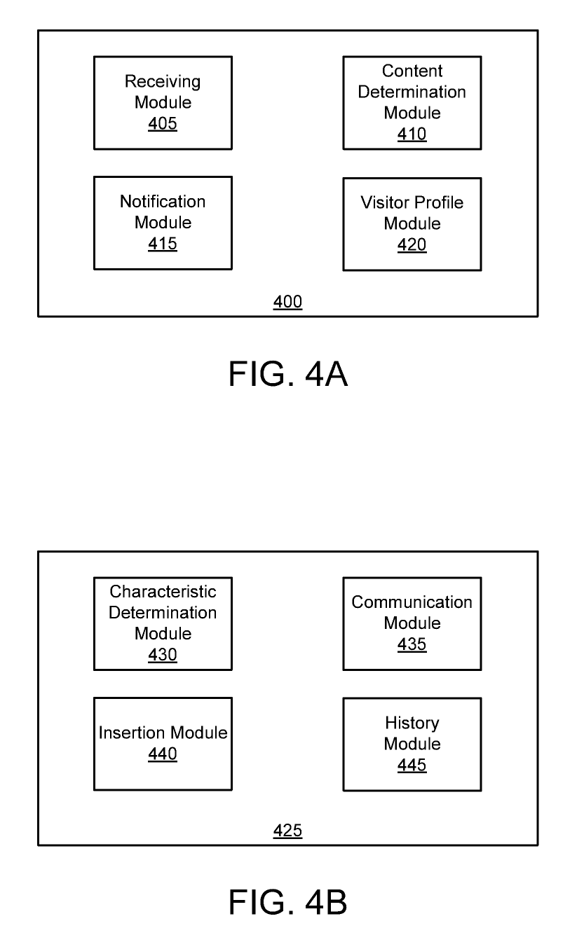

FIG. 4A illustrates another embodiment of an apparatus 400 for dynamically customizing a web page in accordance with the present subject matter. The apparatus 400 includes one or more of a receiving module 405, a content determination module 410, a notification module 415, and a visitor profile module 420. The apparatus 400 may be one embodiment of the Keyword Catcher Apparatus 105. FIG. 4A refers to FIGS. 1 and 2, like-numbered elements corresponding to like-numbered elements.

The receiving module 405, in one embodiment, receives one or more visitor characteristics from a Website Host. The Website Host may host and/or provide the webpage 145 and the website 140. The Website Host may be one embodiment of the Web Owner described above, or may host the web page and website for the Web Owner, although the Web Owner may control, provide, and/or manage the web page content 160, the web page 145, and/or the website 140. References to the Website Host may also, in certain embodiments, refer to a web server 130 of the Website Host, which hosts and provides the web page 145. In one embodiment, the Web server 130 of the Website Host is the Web Owner Server described above.

The receiving module 405 may receive the visitor characteristics from KTC 150 executing on a web page 145 of the Website Host as the web page 145 is being loaded by the Web server 130. As described above, the one or more visitor characteristics may be associated with a Visitor 170a-c visiting a web page 145 of the Website Host. In one embodiment, the receiving module 405 may receive other information from the Website Host such as web page viewing behavior of the Visitor 170a-c visiting the web page. The content determination module, described below, may store the web page viewing behavior for future content determination.

The content determination module 410, in one embodiment, determines web page content 160 for a customizable area on the web page 145. As described above, the customizable area may include the KCC 155. The web page content 160 may be determined based at least in part on the one or more visitor characteristics. In one embodiment, the content determination module 410 locates a web content campaign corresponding to the one or more visitor characteristics. The content determination module 410 may determine the web page content 160 based on the web content campaign as described above in relation to the content determination module 310 of FIG. 3. Moreover, the content determination module 410 may include and/or be one embodiment, of the rules engine 110. In one embodiment, the content determination module 410 may use a default web content campaign if no web content campaign is located based on the visitor characteristics. In certain embodiments, if the Visitor 170a has an existing visitor profile, the content determination module 410 may use a web content campaign corresponding to the visitor profile. For example, if a Visitor 170a arrives at the web page 145 with a direct link (e.g. no search terms, no referring source) and the Visitor 170a is recognized as having an existing visitor profile, the content determination module 410 may use the visitor profile to obtain a preferred web content campaign for the Visitor 170a.

As stated above, a web content campaign may persist for each web page 145 viewed by the Visitor 170a per session on the website 140. Therefore, the content determination module 410 may maintain a common web content campaign for each web page 145 viewed by a common viewer for a particular session.

In one embodiment, the content determination module 410 receives a notification from the Website Host that a hidden Uniform Resource Locator (URL) in the web page 145 has been visited. For example, as described below, the KTC 110 may list certain hidden URLs in the HTML code of the web page 145 to receive an indication from the web browser, using existing web browser functionality, whether the URLs have been visited by the Visitor 170a. This existing functionality is used, among other things, to change the color of a hyperlink to indicate whether it has been visited. The content determination module 410 may determine the web page content based in part based on the hidden URL. For example, if the content determination module 410 receives a notification that a certain URL has been visited (e.g. a website on trucks of a competitor) the content determination module 410 may provide a web content campaign applicable to a Visitor 170a that has visited such websites.

The notification module 415, in one embodiment, notifies the Website Host (e.g. the KTC 110) of the web page content 160 for the Website Host to insert the web page content into the customizable area. The notification module 415 may communicate with the KTC 110 using HTTP and/or HTTPS protocol. In one embodiment, the Website Host inserts the web page content 160 in response to receiving the notification. The notification from the notification module 415 may include a content specification as described above, having file paths to images, videos, graphics, text, HTML snippets, and/or other content specifications to content 160 stored by and/or controlled by the Website Host and/or a Website Owner of the web page 145. In one embodiment, the Website Host (e.g. the KTC 110) inserts the web page content 160 into the web page 145 substantially during loading of the web page 145. In one embodiment, the notification module 415 also notifies the Website Host (e.g. the KTC 150) of characteristics of the customizable area on the web page. For example, the Web Page Owner may have previously set characteristics defining each customizable area (such as a customizable area location on a page, a customizable area size, and the like) in an authoring tool provided by the apparatus 400. The notification module 415 may notify the KTC 150 of these characteristics.

The visitor profile module 420, in one embodiment, creates a visitor profile for the Visitor 170a and stores one or more of the visitor characteristics and web page viewing behavior of the Visitor 170a in the visitor profile. The visitor profile module 420 may be similar to the visitor profile module 325 described above in relation to FIG. 3.

FIG. 4B illustrates yet another embodiment of an apparatus 425 for dynamically customizing a web page in accordance with the present subject matter. The apparatus 425 includes one or more of a characteristic determination module 430, a communication module 435, an insertion module 440, and a history module 445. The apparatus 425 may be one embodiment of the KTC 150 and/or the KTC 150 and the KCC 155. In other embodiments, the apparatus 425 may exist as other code executing on a web server 130 hosting the web page 145 described below. FIG. 4B refers to FIGS. 1 and 2, like-numbered elements corresponding to like-numbered elements.

The characteristic determination module 430, in one embodiment, determines one or more visitor characteristics of a Visitor 170a visiting a web page 145 hosted by a Website Host. As stated above, the Website Host may also, in certain embodiments, be the Web Page Owner. The characteristic determination module 430 may determine the visitor characteristics from the URL of a Visitor 170a (e.g. to obtain search terms in the URL as the Visitor arrives at the web page 145), the web browser of the Visitor 170a, the web server 130 hosting the web page 145, and/or the like.

The communication module 435, in one embodiment, sends the one or more visitor characteristics to a Content Determination Entity (e.g. the Content Determination Entity server 103) and receives a content specification specifying web page content for a customizable area on the web page 145. The web page content that is determined may based at least in part on the one or more visitor characteristics. In one embodiment, the content specification includes file pathnames and other indicators to web content 160 on the Website Host and/or web content 160 owned or managed by the Web Page Owner who owns the web page 145. In one embodiment, the content specification specifies characteristics of the customizable area on the web page 145 (e.g. defining the KCC 155).

In one embodiment, the communication module 435 sends history information to the Content Determination Entity. The history information may specify that particular URLs have been visited. The web content specified by the Content Determination Entity may be based at least in part on the history information. The communication module 435 may also monitor and send web page viewing behavior of the Visitor 170a to the Content Determination Entity.

The insertion module 440, in one embodiment, inserts the web page content into the customizable area during loading of the web page 145. The insertion module 440 may directly insert the content specification (e.g. file path names to images, animation, and the like) into the web page 145. In one embodiment, the insertion module 440 inserts the web page content 160 into the customizable area during loading of the web page 145.

The history module 445, in one embodiment, lists a hidden Uniform Resource Locator (URL) in the web page 145 (e.g. the hidden URL is not viewable by the Visitor in the web browser). The history module 445 may determine, using a web browser for the webpage, that the URL has been visited. For example, as described below, the history module 445 may list certain hidden URLs in the HTML code of the web page 145 to receive an indication from the web browser, using existing web browser functionality, whether the URLs have been visited by the Visitor 170a. The communication module 435 may then communicate this history information to the Content Determination Entity as described above.

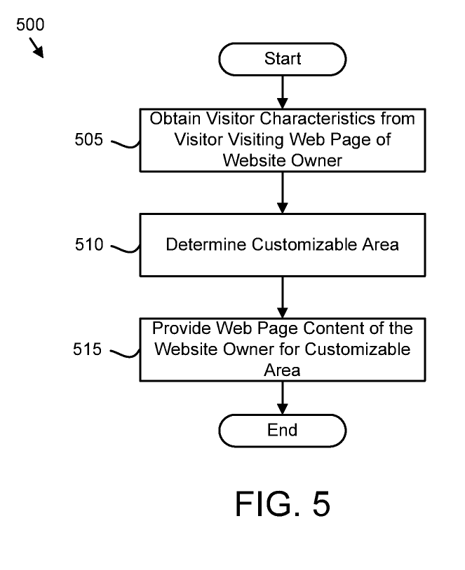

FIG. 5 is a schematic flow chart diagram illustrating one embodiment of a method 500 for dynamically customizing a web page in accordance with the present subject matter. The method 500 refers to the apparatus 300 of FIG. 3. The method 500 begins and the characteristic module obtains 505 one or more visitor characteristics from a Visitor visiting a web page 145 owned by a website owner. The determination module then determines 510 a customizable area on the web page 145. The customizable area comprises a portion of the web page 145 and may be defined by a predetermined indicator (the KCC 155). The customization module 105 then provides 515 web page content for the customizable area based on one or more visitor characteristics of the Visitor 170a. The web page content may be specified and/or defined by one or more the web content campaigns. In one embodiment, if visitor profile module indicates that the Visitor 170a has a pre-existing profile 125, the web page content 105 may be based in part on rules and/or web content campaigns associated with the profile. The web page content includes content of the website owner. In one embodiment, the content of the website owner is stored on servers under control of the website owner (not third party content). Then, the method 500 ends.

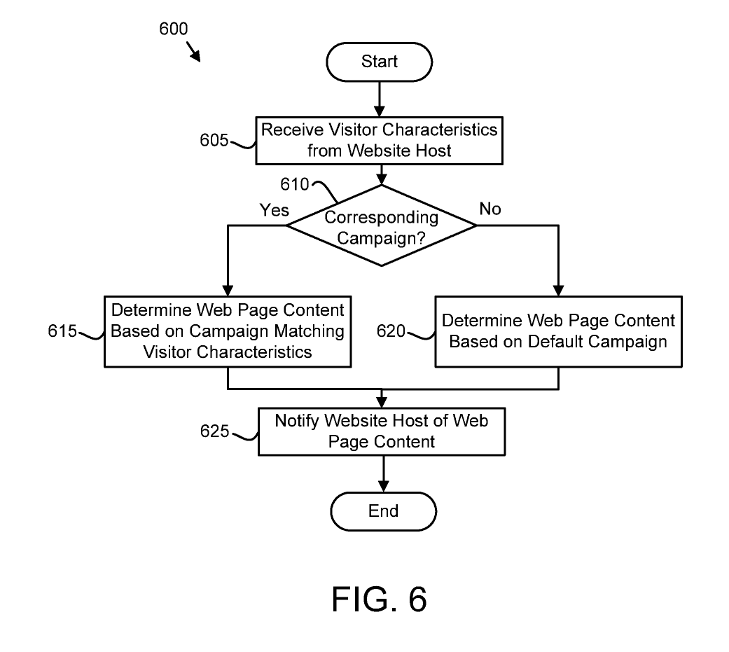

FIG. 6 is a schematic flow chart diagram illustrating another embodiment of a method 600 for dynamically customizing a web page in accordance with the present subject matter. The method 600 refers to the apparatus 400 of FIG. 4A. The method 600 begins and the receiving module 405 receives 605 one or more visitor characteristics from a Website Host. The one or more visitor characteristics are associated with a visitor visiting a web page 145 of the Website Host. The content determination module 410 searches 610 for a web content campaign corresponding to the one or more visitor characteristics. If the content determination module 410 locates 610 a web content campaign that corresponds to the visitor characteristics, the content determination module 410 determines 615 web page content based on the web content campaign. The notification module 415 notifies 625 the Website Host of the web page content and the method 600 ends. Alternatively, if the content determination module 410 fails 610 to locate a corresponding web content campaign, the content determination module 410 determines 620 web page content based on a default web content campaign, the notification module 415 notifies 625 the Website Host of the web page content and the method 600 ends.

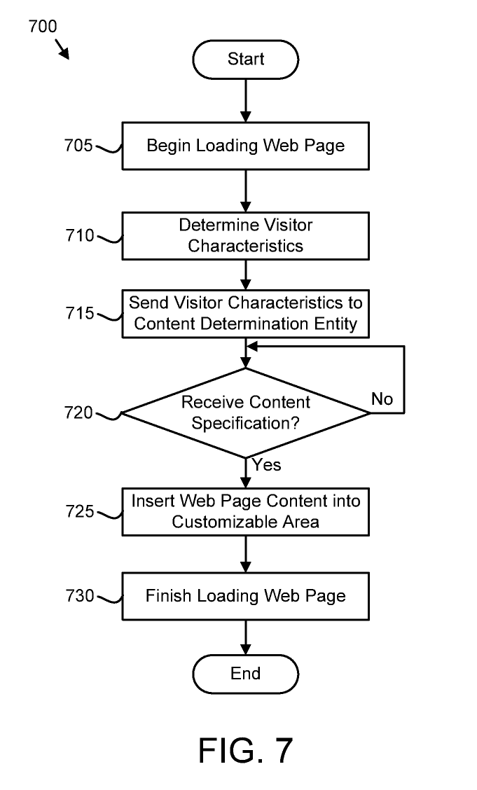

FIG. 7 is a schematic flow chart diagram illustrating yet another embodiment of a method 700 for dynamically customizing a web page in accordance with the present subject matter. The method 700 refers to the apparatus 425 of FIG. 4B. The method 700 begins and a web server 130 of a Website Host begins 705 loading a web page 145 (e.g. for display in a browser). The characteristic determination module 430 determines 710 one or more visitor characteristics of a Visitor 170a visiting the web page 145 (e.g. the Visitor 170a whose browser is accessing the web page 145). The communication module 435 sends 715 the one or more visitor characteristics to a Content Determination Entity. The communication module 435 monitors 720 for a content specification from the Content Determination Entity. The content specification specifies web page content 160 for a customizable area on the web page 145. If the communication module 435 receives 720 the content specification, the insertion module 440 inserts 725 the web page content into the customizable area. The web page content may be managed by the Website Host. The web server 130 finishes 730 loading the web page 145 and the method 700 ends.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a characteristic module configured to obtain one or more visitor characteristics from a visitor visiting a web page, the web page owned by a website owner;
a determination module configured to determine a customizable area on the web page, the customizable area comprising a portion of the web page; and
a customization module configured to provide web page content for the customizable area, the web page content based on the one or more visitor characteristics of the visitor, the web page content comprising content of the website owner.

2. The apparatus of claim 1, wherein the one or more visitor characteristics comprise one or more of keyword information, referring information, demographic information, browser information, device type, time, and social networking information.

3. The apparatus of claim 1, wherein the customization module is further configured to insert the web page content into the customizable area during loading of the web page.

4. The apparatus of claim 1, further comprising a visitor profile module configured to create a visitor profile for the visitor and storing one or more of the visitor characteristics and web page viewing behavior of the visitor in the visitor profile.

5. The apparatus of claim 1, further comprising a visitor profile module configured to recognize the visitor as being associated with an existing visitor profile and update the existing visitor profile based on one or more of the visitor characteristics and web page viewing behavior of the visitor.

6. The apparatus of claim 1, further comprising a campaign module configured to locate a web content campaign corresponding to the one or more visitor characteristics, the apparatus further comprising a content determination module configured to determine the web page content based on the web content campaign.

7. An apparatus comprising:
a receiving module configured to receive one or more visitor characteristics from a website host, the one or more visitor characteristics associated with a visitor visiting a web page of the website host;
a content determination module configured to determine web page content for a customizable area on the web page, the web page content determined based at least in part on the one or more visitor characteristics; and
a notification module configured to notify the website host of the web page content for the website host to insert the web page content into the customizable area.

8. The apparatus of claim 7, wherein the one or more visitor characteristics comprise one or more of keyword information, referring information, demographic information, browser information, device type, time, and social networking information.

9. The apparatus of claim 7, wherein the website host inserts the web page content into the web page substantially during loading of the web page.

10. The apparatus of claim 7, wherein the content determination module is further configured to locate a web content campaign corresponding to the one or more visitor characteristics and determine the web page content based on the web content campaign.

11. The apparatus of claim 7, further comprising a visitor profile module configured to create a visitor profile for the visitor, the visitor profile comprising one or more of the visitor characteristics and web page viewing behavior of the visitor.

12. The apparatus of claim 7, further comprising a visitor profile module configured to recognize the visitor as being associated with an existing visitor profile and update the existing visitor profile based on one or more of the visitor information and web page viewing behavior of the visitor.

13. The apparatus of claim 7, wherein the notification module is further configured to notify the website host of characteristics of the customizable area on the web page, the characteristics comprising one or more of a customizable area location and a customizable area size.

14. The apparatus of claim 7, wherein the content determination module is configured to receive a notification from the website host that a hidden Uniform Resource Locator (URL) in the web page has been visited, wherein the content determination module is configured to determine the web page content based in part on the hidden URL.

15. The apparatus of claim 7, wherein the receiving module is further configured to receive from the website host, web page viewing behavior of the visitor visiting the web page of the website host, wherein the content determination module stores the web page viewing behavior for future content determination.

16. An apparatus comprising:
a characteristic determination module configured to determine one or more visitor characteristics of a visitor visiting a website hosted by a website host;
a communication module configured to send the one or more visitor characteristics to a content determination entity and configured to receive a content specification specifying web page content for a customizable area on the web page, the web page content determined based at least in part on the one or more visitor characteristics; and
an insertion module configured to insert the web page content into the customizable area during loading of the web page, the web page content managed by the website host.

17. The apparatus of claim 16, wherein the one or more visitor characteristics comprise one or more of keyword information, referring information, demographic information, browser information, device type, time, and social networking information.

18. The apparatus of claim 16, further comprising a history module configured to list a hidden Uniform Resource Locator (URL) in the web page and configured to determine, using a web browser for the webpage, that the URL has been visited.

19. The apparatus of claim 18, wherein the communication module is further configured to send history information to the content determination entity, the history information specifying that the URL has been visited, wherein the web content is based at least in part on the history information.

20. The apparatus of claim 16, wherein the content specification specifies characteristics of the customizable area on the web page, the characteristics comprising one or more of a customizable area location and a customizable area size.
